(19) United States
(12) Patent Application Publication
(10) Pub. No.: US 2005/0160709 A1
(43) Pub. Date: Jul. 28, 2005

(54) High efficiency air filter and method of forming

(75) Inventor: John P. Hollis, Coral Springs, FL (US)

Correspondence Address: PEARNE & GORDON LLP, 1801 EAST 9TH STREET, SUITE 1200, CLEVELAND, OH, 44114-3108, US

(73) Assignee: DOMETIC CORPORATION, Pompano Beach, FL (US)

(21) Appl. No.: 10/765,095

(22) Filed: Jan. 28, 2004

(51) Int. Cl. B01D 46/00

(52) U.S. Cl. 55/497; 55/521; 55/528; 55/501

(57) ABSTRACT

An air filter for use in vehicle air conditioning/handling systems includes a pleated filter material having a MERV of more than 1 and preferably of at least 8. The pleated filter material has a wire mesh disposed on its back or downward air flow side, and is encased within a frame for easy installation into air handling equipment. The frame has a relatively slim profile of less than 0.22 inches, and has relatively narrow frame rails of less than 0.625 inches in width so as to beneficially reduce the air pressure drop across the air filter when installed in the vehicle's air conditioning/handling equipment.

### FIELD OF THE INVENTION

The present invention relates to a high efficiency air filter for use in air conditioning or air handling systems installed on land and water vehicles, including boats and trucks. More particularly, the present invention relates to a high efficiency air filter for use in air conditioning/handling systems and for capturing air stream particulates, bilge and diesel fuel odors in land and water going vehicles and vessels.

### BACKGROUND OF THE INVENTION

Prior art vehicle air conditioning/handling system air filters have typically comprised materials having a relatively low Minimum Efficiency Reporting Value (MERV) of 1. MERV ratings are defined in ASHRAE Standard 52.2. For example, FIG. 1 shows a black mesh filter material often used in such systems and having a MERV of 1. FIG. 2 shows an aluminum “grease trap” type filter material also often used in such systems and also having a MERV of 1. Finally, FIG. 3 shows a foam filter material also often used in such systems and also having a MERV of 1.

System air filters made of the materials shown in FIGS. 1-3 have proven to be ineffective and inefficient in capturing air stream particulates, bilge and diesel fuel odors present in boats, trucks and other land and water vehicles. In particular, air filters containing filter materials having a MERV of 1 do not capture particulates on the order of 10 μm or smaller.

In addition to utilizing relatively inefficient materials, prior art system air filters have been framed in ways which result in significant air pressure drop across the air filter when in use. For example, utilizing frames in which the filter material is framed flat and in which the frame rail widths are approximately one inch causes significant air pressure drop across the air filter and system.

In view of more limiting environmental standards and laws, including laws promulgated to restrict the prolonged idling of vehicle engines, the prior art filters used on air conditioning/handling equipment in boats and trucks have proven to be ineffective and/or inefficient for their intended purposes of removing particulate, bilge and diesel odors from the ambient air breathed by the operator and passengers of the vehicle or vessel.

### SUMMARY OF THE INVENTION

It is an object of the present invention to overcome the deficiencies in the prior art air filters. Accordingly, the present invention employs an air filter material having a higher efficiency rating, i.e., material having a MERV higher than 1 and preferably having a MERV of at least 8. By using material having a MERV higher than 1, the present invention can more effectively and efficiently eliminate, air stream particulates, bilge and diesel fuel odors.

High efficiency air filter material having a MERV of 8 can be obtained, for example, from Hollinee Filtration and has the product name, Electrostat® 50, and product code E050/115. The air filter material preferably has a media weight of 65 grams per meters squared (g/m²), and typically comprises 50 g/m² of modacrylic/polypropylene fiber composition together with 15 g/m² of spunbond polyester.

It is another object of the present invention to frame the high efficiency air filter material so as to reduce the air pressure drop across the air filter when employed in air conditioning/handling equipment in land and water vehicles. Accordingly, the relatively high efficiency material is preferably pleated before setting it into a square or rectangular frame. The pleats function to increase, by approximately 50%, the surface area of the filter material within the frame. Pleating the filter material allows the air filter to achieve a beneficial reduction in pressure drop as compared to framing the filter material flat.

A wire mesh is preferably provided on the downward air flow side of the pleated filter material to prevent ballooning of the filter material as the air flow traverses through the filter. The wire mesh also serves to capture and maintain the edges of the filter material within the frame. Preferably the wire mesh is made of a oxidation resistant material to significantly reduce or eliminate oxidation potential. However, as will be recognized by those skilled in the art other non-oxidizing materials such as, for example, plastic could also be used for the mesh.

Alternatively, if wire mesh is not provided, the edges of the filter material can be maintained within the frame by using suitable means to ensure that the filter material is not pulled out of the frame via the air flow traversing through the frame. Such means can include using a molded frame to more securely hold the filter material, a sewn frame wherein the filter material is securely sewn within the frame, etc.

A rectangular or square frame sandwiches the pleated filter material and wire mesh, and has a relatively slim profile to fit into tight spaces found in land and water vehicle applications. The frame is approximately 0.220 inches in depth so as to easily fit into existing air conditioning/handling product envelopes without adding to the overall applied depth of the product.

The frame is preferably rectangular in shape, and provides a sufficiently large opening so as not to unduly restrict the air flow through the filter material at its interior. More particularly, the frame is restricted to a five/eighths (0.625) inches or less width border around its periphery. Limiting the width of the border serves to reduce the pressure drop that would normally be experienced with, for example, a standard one inch width border filter frame.

As noted above the frame is assembled so as to sandwich the pleated material and, if included, the wire mesh between its borders. More particularly, the frame is sewn, molded or glued together so as to hold the frame flat as it is applied to air conditioning/handling equipment or the like. The use of the sewn, molded or glued frame further serves to prevent the filter material from pulling away from the frame when in use and to capture the sharp ends of the wire mesh so as to provide a safety barrier for users during the installation and removal of the filter from the air handling equipment or the like. When used, the wire mesh also serves to prevent ballooning of the filter material and to capture and secure the edges of the filter material within the frame.

### BRIEF DESCRIPTION OF THE DRAWINGS

FIG. 1 shows a black mesh air filter material typically used for marine applications;

FIG. 2 shows an aluminum “grease trap” type air filter material typically used in marine applications;

FIG. 3 shows a foam air filter material typically used in marine applications;

FIG. 4 shows a front view of an exemplary embodiment of the air filter in accordance with the present invention;

FIG. 5 shows a back view of the air filter shown in FIG. 4;

FIGS. 6A and 6B show, respectively, left and right side retaining rails provided for holding the air filter shown in FIG. 4 in place;

FIG. 7 shows the air filter of FIG. 4 being installed;

FIG. 8 shows the air filter of FIG. 4 completely installed;

FIG. 9 shows the left retaining rail area with the air filter installed;

FIG. 10 shows, in schematic form, an assembly detail of the air filter frame; and

FIG. 11 shows, in schematic form, a top view of the assembled air filter frame.

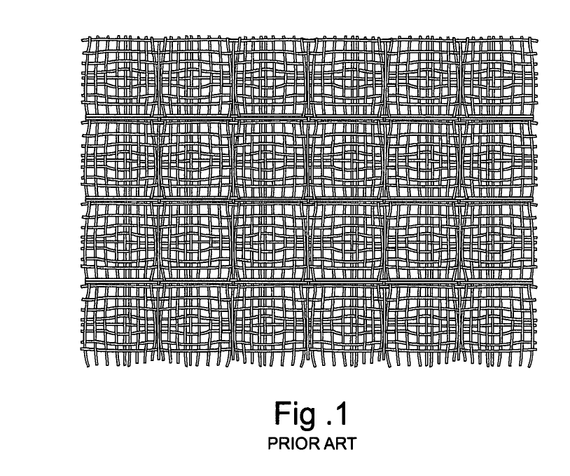

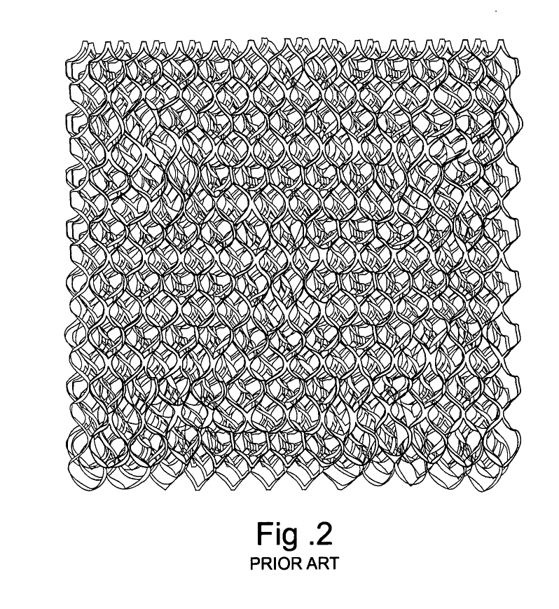

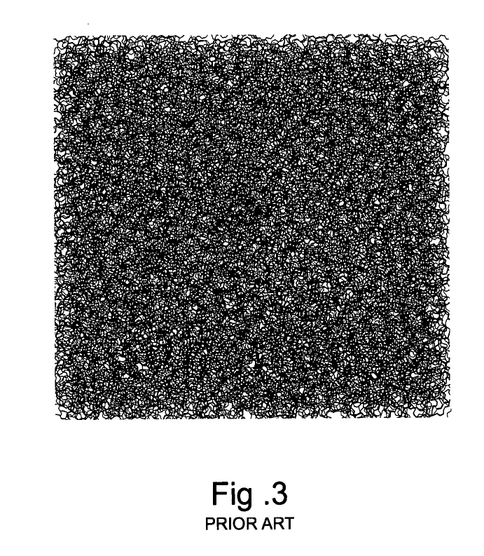

### DETAILED DESCRIPTION OF THE INVENTION

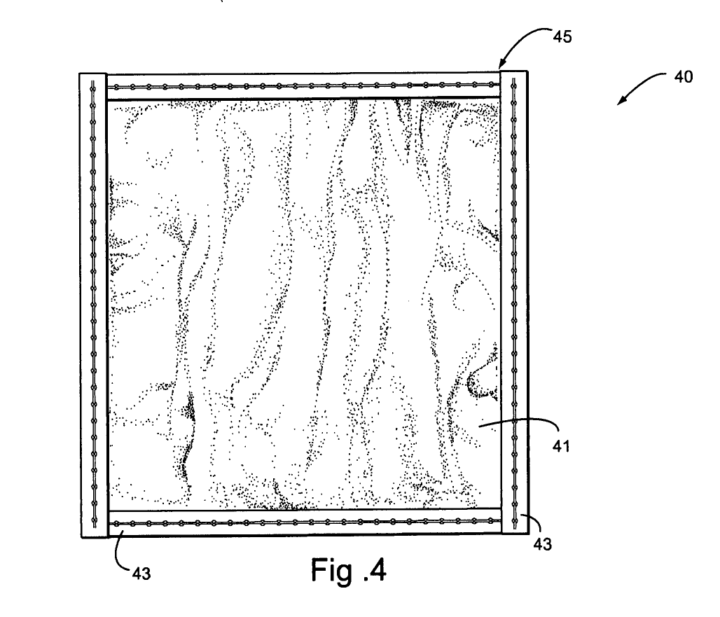

FIGS. 4 and 5 show front and back views, respectively, of air filter 40 according to an exemplary embodiment of the present invention. Air filter 40 includes pleated material 41 having, for example, a fiber composition of modacrylic/polypropylene and a carrier composition of spunbond polyester. In the preferred embodiment, the filtered material includes approximately 50 g/m² of the fiber composition and approximately 15 g/m² of the carrier composition for a total weight of approximately 65 g/m².

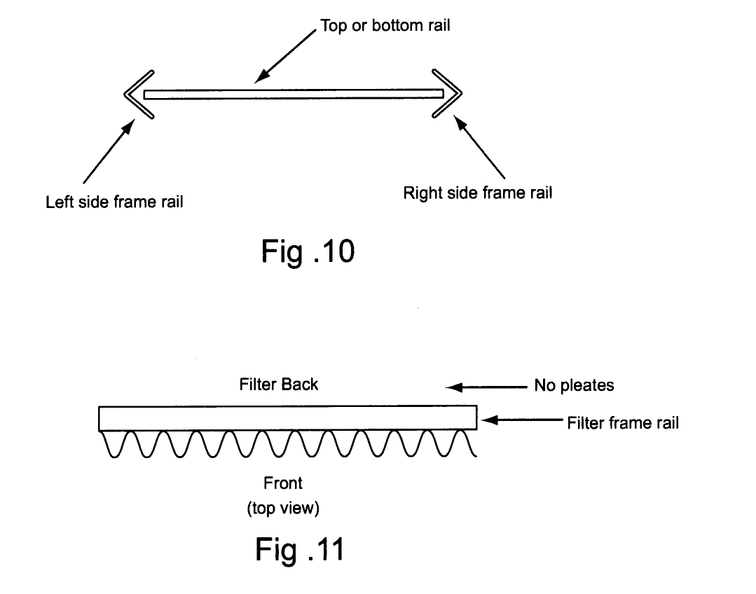

In the preferred embodiment, pleated material 41 together with wire mesh 42 is sandwiched between front and back frame rails 43,44 which when assembled together form frame 45. Frame 45 is preferably square or rectangular in shape with the top and bottom rails being disposed between the right and left side rails, as shown in FIG. 10. The pleated material 41 is disposed within frame 45 so that the pleats project from the front side of frame 45, as shown in FIG. 11.

Frame 45 can be assembled by being sewn (shown in FIGS. 4 and 5), glued (not shown) or molded (not shown). Virtually any method of assembly is acceptable provided that the sharp ends of wire mesh 42 are securely contained between the edges of frame rails 43, 44 during use of the air filter including its installation and removal. As assembled into frame 45, pleated material 41 has wire mesh 42 covering its back or downward air flow side, with the edges of wire mesh 42 covered by the assembled frame rails 43, 44.

Preferably the pleats of pleated material 41 run vertically and, for example, are spaced about 1 inch apart. Frame rails 43,44 can be formed from cardboard or polymer strips having a one and one-quarter (1.25) inch width and five/hundredths (0.05) thickness. The cardboard strips having these dimensions can be folded in half to form front and back frame rails 43,44 having widths of 0.625 inches and depths of less than 0.22 inches when pleated material 41 and wire mesh 42 are positioned there-between.

Frame 45 has a relatively slim profile, typically less than 0.22 inches in depth, and the width of the frame rails, that sandwich the outer periphery of pleated material 41 and wire mesh 42, are limited to approximately five/eighths (0.625) of an inch. Limiting the width of the frame borders to 0.625 inch or less achieves a beneficial reduction in the pressure drop as compared to frames having greater frame border widths.

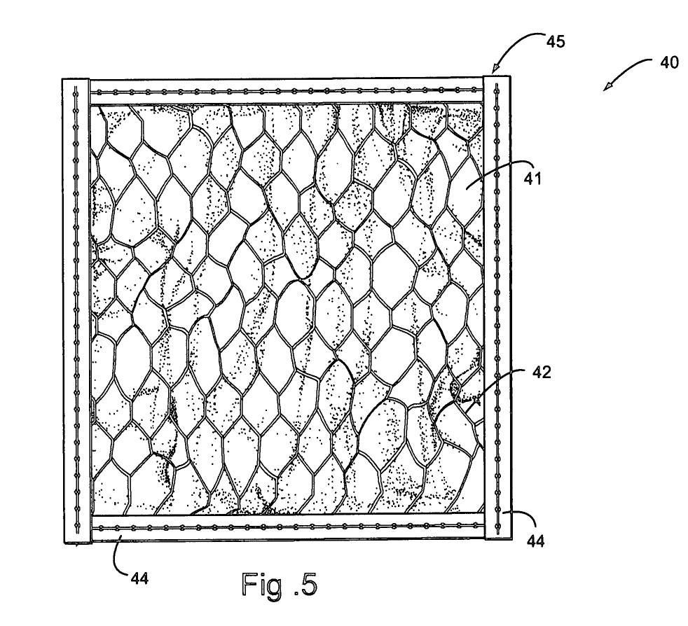

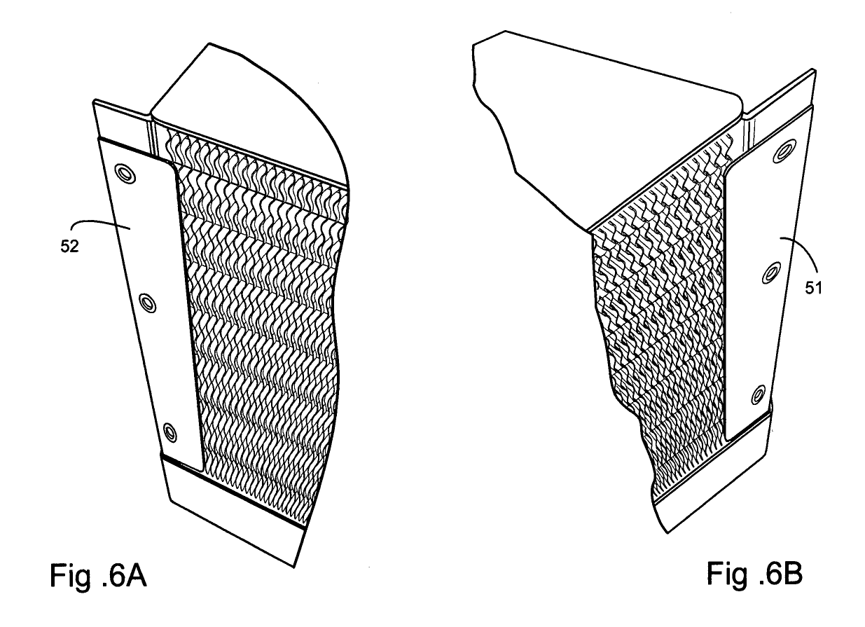

FIGS. 6A and 6B show, respectively, right and left retaining rails 51,52 between which air filter 40 is installed. As shown, right and left retaining rails 51,52 have a slim profile that corresponds with the slim profile of air filter 40. Retaining rails 51,52 carried by, for example, an air handler (not shown) do not add appreciably to the overall envelope or configuration of the air handler because of their slim profile.

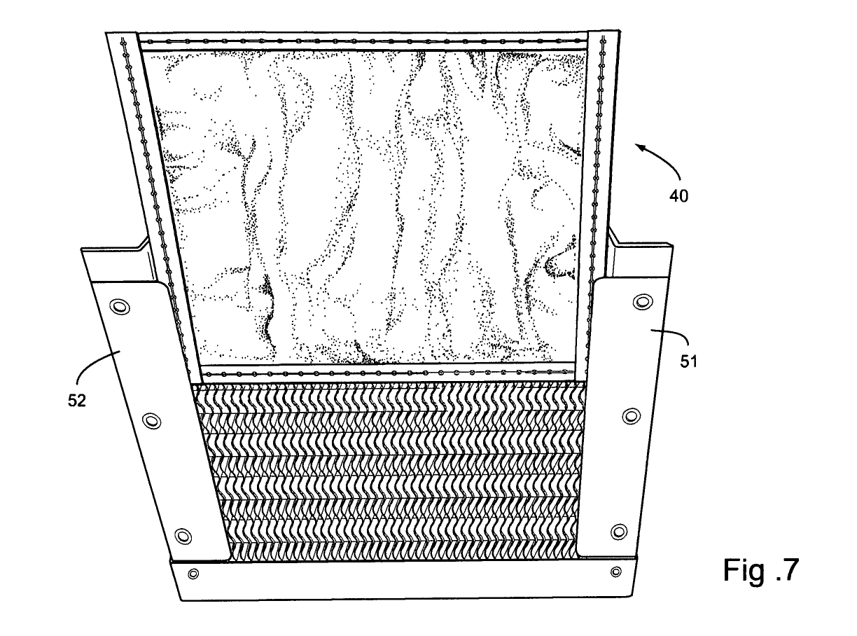

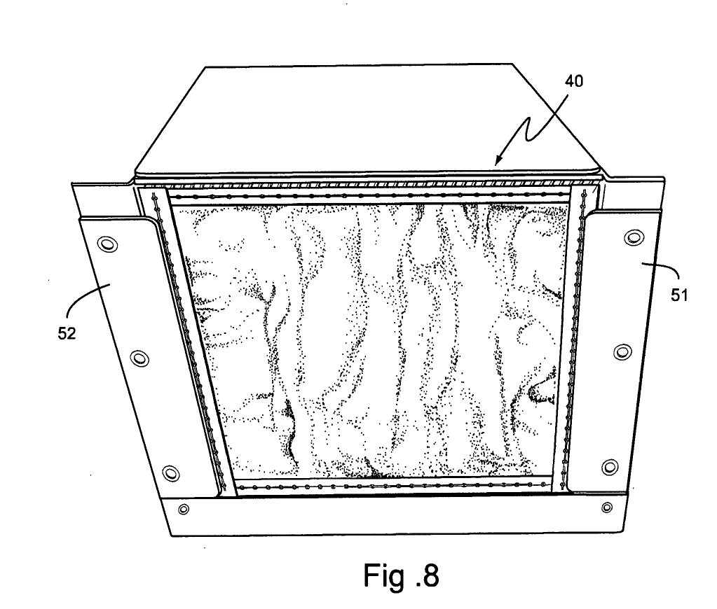

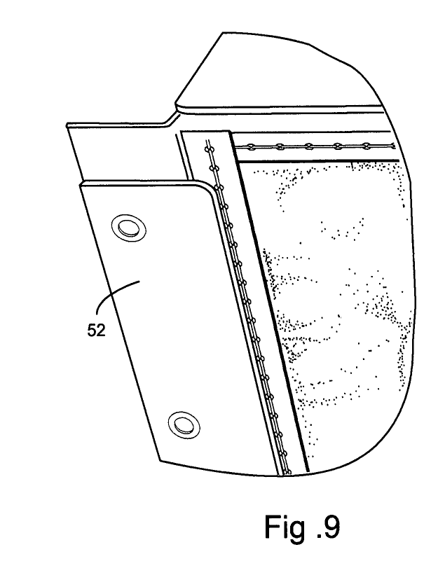

FIGS. 7-9 show the process of installing air filter 40. More particularly, FIG. 7 shows air filter 40 being inserted between retaining rails 51,52, and FIG. 8 shows air filter 40 completely installed between retaining rails 51,52. FIG. 9 shows in greater detail left retaining rail 52 holding air filter 40 in place with minimal or no air flow obstruction to the filter area of air filter 40.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. An air filter for a vehicle air conditioning/handling system comprising:
a pleated filter material having a MERV of more than 1; and
a frame for securely holding outer edges of the pleated filter material.

2. An air filter as claimed in claim 1, said frame being less than 0.220 inches in depth and having rails of no more than 0.625 inches in width.

3. An air filter as claimed in claim 1, said pleated filter material comprising a fiber composition of modacrylic/polypropylene and a carrier composition of spunbond polyester.

4. An air filter as claimed in claim 3, said fiber composition being 50 g/m² and said carrier composition being 15 g/m².

5. An air filter as claimed in claim 1, said filter material having a MERV of 8.

6. An air filter as claimed in claim 2, said filter material having a MERV of 8.

7. An air filter as claimed in claim 3, said filter material having a MERV of 8.

8. An air filter as claimed in claim 4, said filter material having a MERV of 8.

9. An air filter as claimed in claim 1, said frame being glued.

10. An air filter as claimed in claim 1, said frame being sewn.

11. An air filter as claimed in claim 1 said frame being molded.

12. An air filter as claimed in claim 1, further including wire mesh positioned on one side of said pleated filter material with outer edges of said wire mesh being held within said frame.

13. An air filter as claimed in claim 2, further including wire mesh positioned on one side of said pleated filter material with outer edges of said wire mesh being held within said frame.

14. An air filter as claimed in claim 4, further including wire mesh positioned on one side of said pleated filter material with outer edges of said wire mesh being held within said frame.

15. An air filter as claimed in claim 5, further including wire mesh positioned on one side of said pleated filter material with outer edges of said wire mesh being held within said frame.

16. A method of forming an air filter for a vehicle air conditioning/handling system, said method comprising:
assembling a rectangular frame from front and back frame rails each having a width of no more than 0.625 inches; and
positioning outer edges of a pleated filter material, having a MERV of more than 1, within the rectangular frame.

17. A method of forming an air filter as claimed in claim 16, wherein said assembling the rectangular frame further includes disposing top and bottom rails of the rectangular frame within right and left side rails of the rectangular frame.

18. A method of forming an air filter as claimed in claim 16, further including positioning a wire mesh at one side of the pleated filter material and within the rectangular frame.

19. A method of forming an air filter as claimed in claim 17, further including positioning a wire mesh at one side of the pleated filter material and within the rectangular frame.

20. A method of forming an air filter as claimed in claim 18, wherein an overall depth of the pleated filter material, the wire mesh and the front and back frame rails is equal to or less than 0.22 inches.

21. A method of forming an air filter as claimed in claim 19, wherein an overall depth of the pleated filter material, the wire mesh and the front and back frame rails is equal to or less than 0.22 inches.

22. A method of forming an air filter as claimed in claim 16, the pleated filter material having a MERV of at least 8.

23. A method of forming an air filter as claimed in claim 17, the pleated filter material having a MERV of at least 8.

24. A method of forming an air filter as claimed in claim 18, the pleated filter material having a MERV of at least 8.

25. A method of forming an air filter as claimed in claim 19, the pleated filter material having a MERV of at least 8.

26. A method of forming an air filter as claimed in claim 20, the pleated filter material having a MERV of at least 8.

27. A method of forming an air filter as claimed in claim 21, the pleated filter material having a MERV of at least 8.
